(19) United States
(12) Patent Application Publication
(10) Pub. No.: US 2006/0135340 A1
(43) Pub. Date: Jun. 22, 2006

(54) Spherical nano-composite powder and a method of preparing the same

(76) Inventors: Hong Ning Philip Cheang, SINGAPORE (SG); Rajendra Kumar slo N. Kasinath, Singapore (SG); Khiam Aik Khor, Singapore (SG)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/522,866

(22) PCT Filed: Jul. 30, 2003
(86) PCT No.: PCT/SG03/00179

§ 371 Date: Sep. 26, 2005

Related U.S. Application Data
(60) Provisional application No. 60/399,938, filed on Jul. 30, 2002.

(51) Int. Cl. C04B 35/48

(52) U.S. Cl. 501/1; 501/104

(57) ABSTRACT

The present invention provides a composition and method of producing nano-composite powder consisting essentially of hydroxyapatite (HA) and zirconium oxide (ZrO2). The method comprises the steps of reacting orthophosphoric acid with calcium hydroxide to form a HA suspension, adding ZrO2 suspension to the HA suspension to form a composite feedstock, and subjecting the composite feedstock to Radio Frequency (RF) Plasma Spraying to form the nano-composite powder. Quantity of the zirconium oxide suspension added is in the range of 10 to 40 weight % of the composite feedstock. The nano-composite powder comprises 60-90 wt % calcium hydroxyapatite, 10-40 wt % zirconium oxide and traces of calcium phosphate.

### FIELD OF INVENTION

The invention generally relates to a composition and method of producing nano-composite powders, in particular nano-composite calcium hydroxyapatite strengthened with zirconium oxide.

### BACKGROUND

The study of biomaterials has seen immense growth over the last two decades. A new generation of bio-active materials has emerged promising better properties over existing biomaterials because of their ability to promote intimate bone growth and rapid fixation. In this respect hydroxyapatite (HA) has been recognised as a bioactive material having the potential for development as a bone substitute.

Biological compatibility of HA is strongly dependent on its crystallinity and phase content. Preventing decomposition of HA into more resorbable phases such as tricalcium phosphate (TCP), tetracalcium phosphate (TTCP) is therefore crucial in controlling the physiological stability of HA. A need thus exists to control the physiological stability of HA for this purpose.

HA is a very brittle ceramic with fracture toughness that is lower than 1 MPam^{1/2} which prevents its use in loaded situations. As such its present application is limited to non-load bearing maxillo-facial implants and dental fillers. Therefore, a need exists to improve the mechanical properties (mainly fracture toughness) of HA.

### SUMMARY

An aspect of the present invention is to provide a method of producing nano-composite powder consisting essentially of hydroxyapatite (HA) and zirconium oxide (ZrO₂) comprising the steps of reacting orthophosphoric acid with calcium hydroxide to form a HA suspension, adding ZrO₂ suspension to the HA suspension to form a composite feedstock, and subjecting the composite feedstock to Radio Frequency (RF) Plasma Spraying to form the nano-composite powder. Quantity of the zirconium oxide suspension added is in the range of 10 to 40 weight % of the composite feedstock.

Another aspect of the present invention is to provide a nano-composite powder comprising 60-90 wt % calcium hydroxyapatite, 10-40 wt % zirconium oxide and traces of calcium phosphate.

### BRIEF DESCRIPTION OF DRAWINGS

These and other features, objects and advantages of embodiments of the invention will be better understood and readily apparent to one of ordinary skill in the art from the following written description, in conjunction with drawings, in which:

FIG. 1 shows the variation of particle size of nano-composite powders as a function of quantity of zirconium oxide added.

FIG. 2a shows a SEM micrograph of the general morphology of nano HA powder without ZrO₂ particles.

FIG. 2b shows a SEM micrograph of the morphology of nano-composite ZrO₂/HA powder (40% ZrO₂/HA) with embedded spherical ZrO₂ particles.

FIG. 2c shows a SEM micrograph of the morphology of nano-composite ZrO₂/HA powder (40% ZrO₂/HA) with embedded irregular shaped ZrO₂ particles.

FIG. 2d shows a SEM micrograph of the morphology of nano-composite ZrO₂/HA powder (40% ZrO₂/HA) with surface attached spherical ZrO₂ particles.

FIG. 2e shows a SEM micrograph of the morphology of nano-composite ZrO₂/HA powder (40% ZrO₂/HA) with embedded cubic ZrO₂ particles.

FIG. 2f shows a SEM micrograph of the morphology of HA powder with cubic pores.

FIG. 3 shows a TEM micrograph of ZrO₂/HA nano-composite powders.

(40% ZrO₂/HA) before and after Radio Frequency Plasma Spraying.

FIG. 4 shows X-ray diffraction pattern of the as-sprayed ZrO₂/HA nano-composite powders.

### DETAILED DESCRIPTION

An embodiment of the invention is to provide a composition and method of manufacturing nano-composite hydroxyapatite (HA) powders which exhibits enhanced physiological stability and improved mechanical properties. In order to achieve this, zirconium oxide (ZrO₂) is added to the hydroxyapatite to form nano-composite ZrO₂/HA powders.

Calcium Hydroxyapatite, commonly known as Hydroxyapatite (HA), is produced in-house using wet chemical approach by reacting orthophosphoric acid (H₃PO₄) with calcium hydroxide (Ca(OH)₂). This results in a formation of calcium hydroxyapatite suspended in water. The HA suspension is stirred for two hours and left to settle overnight. Thickening of gelatinous HA precipitate in water is achieved by centrifugation. Monoclinic ZrO₂ suspension (of particle size <100 nm) is then added to the HA suspension to produce a composite feedstock. Samples of composite feedstock with varying quantities of ZrO₂ suspension and HA suspension in the following quantities, 10/90, 20/80, 30/70 and 40/60 wt % ZrO₂/HA are produced.

The suspension is then fed axially into an induction plasma by a special atomisation probe. Atomisation parameters (suspension flow rate, gas flow rate and angle of atomisation) were adjusted for optimum flow as shown in Table 1.

TABLE 1
Parameters used for atomising the suspension feedstock.

| Atomisation parameters | Settings |
|---|---|
| Atomising gas (slpm) | 4-5 |
| Angle of atomisation | 90-100° |
| HA suspension flow rate (g/min) | 6 |
| Solid content of suspension (wt %) | 13 |

The same parameters were maintained throughout the investigation. Plasma spraying was carried out on a 35-kW, Tekna Plasma System Inc., with RF plasma torch (PL-35) operating at 3 MHz. Argon is used for both the plasma forming gas and atomisation gas. Spraying parameters are summarised in Table 2.

TABLE 2
Parameters used for RF plasma spraying

| RF plasma parameters | Settings |
|---|---|
| Plate power (kW) | 12.5 |
| Chamber pressure (kPa) | 53.2 |
| Probe position (cm) | 3.5 |
| Ar central gas flow rate (slpm) | 20 |
| Ar sheath gas flow rate (slpm) | 50 |

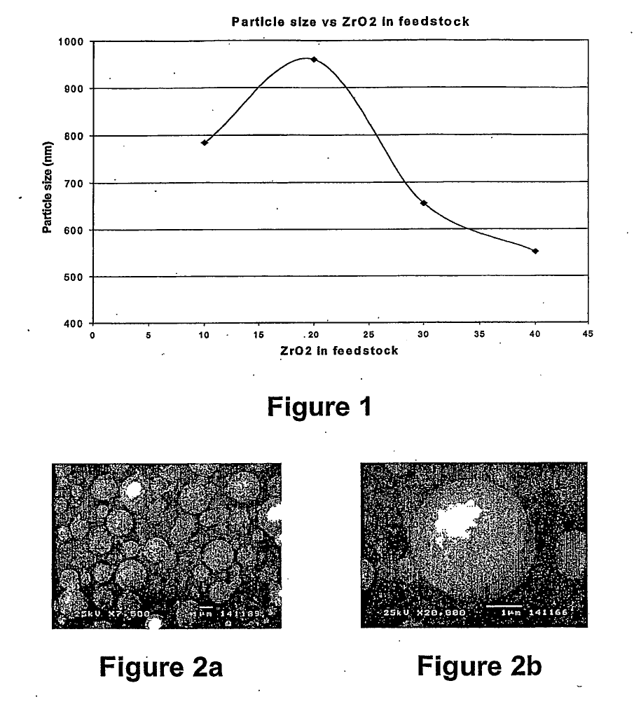

The average particle size variation of the as-sprayed nano-composite ZrO₂/HA powders with increasing ZrO₂ in the feedstock is shown in FIG. 1.

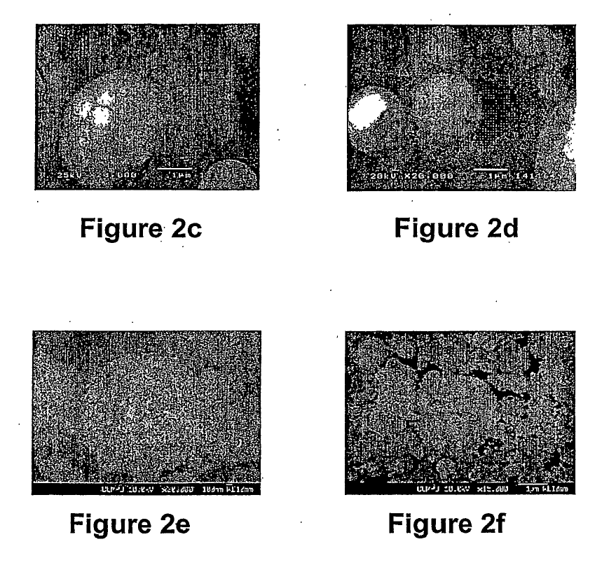

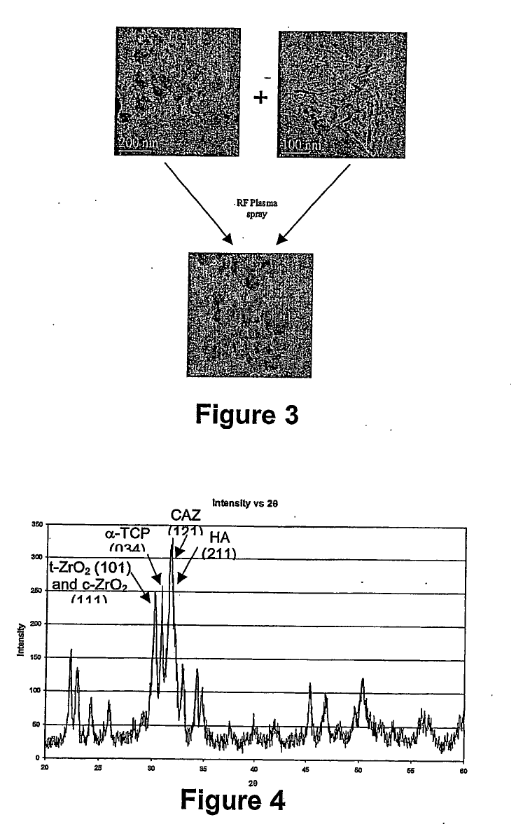

The morphology of the as-sprayed nano-composite ZrO₂/HA powders is shown in FIG. 2 (SEM and FEM) and that of medium and large particle sized powders in FIG. 3 (SEM).

Nano-composite HA/ZrO₂ powders of the present invention consists essentially of a mixture of HA/calcium phosphate (CaPO₄) particles and HA/CaPO₄/ZrO₂ composite particles. The powders comprises two kinds of particle size distributions: particle sizes in the range 1-3 μm, and particle sizes smaller than 200 nm for the nano-composite powders. Four different morphologies for the HA/CaPO₄/ZrO₂ composite particles were present:
1. Embedded islands of secondary particles (FIGS. 2c and 2e),
2. Embedded nano-sized secondary particles (FIG. 2b),
3. Surface attached secondary particles (FIG. 2d) and
4. HA particles with nano-pores (FIG. 2f), the pores originating from ejected secondary particles once part of the original HA sphere (FIG. 2e).

The morphology seen in FIG. 2b is predominant in the composite powders of the present invention (−70%) as compared to that in FIG. 2c. The morphology of the medium sized composite powders is similar to that of the nano-composite powders except for the size difference. The large particle sized powders showed similar amount of secondary nano ‘alloyed’ particles. One clear feature of the composite powders, regardless of size is the high level of dispersion of the secondary particles, seemingly well spaced out. This indicates that a similar sort of dispersion could have been present in the feedstock due to the surface chemistry of the ZrO₂ and HA particles in suspension.

The final morphology of the powders is also due to the thermal history of the particles in the plasma. In the plasma, the liquid in the atomised droplets containing HA and ZrO₂ would have first undergone flash evaporation. Following this the somewhat consolidated particle would have melted and spherodised to varying degrees trapping whatever secondary particles present in them. As the particles leave the plasma they would have rapidly cooled producing HA with varying amounts of embedded secondary particles.

The as-sprayed nano-composite powders is then sintered by Spark Plasma Sintering (SPS). After polishing, the hardness and fracture toughness were calculated from micro-indentation techniques. The values were then compared to that of HA powders (˜10 μm) sintered conventionally and ultra-fine HA powders sintered by SPS. The Young's Modulus, fracture toughness and micro-hardness values of the various compacts are shown comparatively in Table 3.

TABLE 3
Mechanical properties of the as-sintered compacts.

| | | Fracture | |
|---|---|---|---|
| | Young's | Toughness | |
| Powder type | Modulus (GPa) | (MPam^{1/2}) | Hardness |
| Conventionally | 87 ± 4 [8] | 0.77 ± 0.12 [8] | 508 ± 40 HV [9] |
| sintered powders | | | |
| (at 1100° C.)* | 103 ± 9 | 1.17 ± 0.11 | 5.7 ± 0.3 GPa |
| RFSPS ultra-fine | | | |
| Powders | | | |
| (HA + CaPO₄) | | | |
| RFSPS ultra-fine | 130 ± 6 | 1.60 ± 0.21 | 5.5 ± 0.5 GPa |
| powders | | | |
| (HA + CaPO₄ + | | | |
| ZrO₂) | | | |
| Medium | 106 ± 4 | 1.41 ± 0.11 | 5.2 ± 0.2 GPa |
| (HA + CAP + | | | |
| ZrO₂) | | | |

*Values are for conventionally sintered powders by other researchers.

The results indicate that the compacts with ZrO₂ had higher Young's Modulus, fracture toughness and hardness than the one without. Fracture toughness of the compacts sintered from the ultra-fine powders is about 1.60 MPam^{1/2} and for the medium sized powders is about 1.41 MPam^{1/2}. The sintered composite compacts were also annealed to see the effect of heat treatment on the mechanical property changes. These changes to the mechanical properties are rather substantial considering the minimal loading of ZrO₂ (˜1vol %).

It has been shown that ultra-fine/nano-composite powders of ZrO₂/HA can be produced using the Radio Frequency Suspension Plasma Spraying Technique (RFSPS). The various morphologies of the powders indicated that nano-sized ZrO₂ particles existed both within and as surface-attachments on HA particles. QPA indicated that HA and ZrO₂ reacted in the plasma, giving rise to partially stabilised zirconia (PSZ) and CaZrO₃ (CAZ). Also, ZrO₂ content did not change appreciably after 20 wt % ZrO₂ in the feedstock. DSC also showed a small amount of amorphous calcium phosphate in the as-sprayed powders. The experiment confirmed that nano-composite powders of HA/ZrO₂ with controlled composition can be produced using the RF suspension plasma spraying technique. The nano-ZrO₂ present in the powders was partially stabilised in-situ, in the presence of CaO from HA, during the plasma spraying process.

The mechanical properties of the compacts sintered from the HA/ZrO₂ nano-composite powders were substantially higher those without considering the low volume loading of ZrO₂ in the powders. As such it is possible that even further additions of ZrO₂ in the powders during suspension plasma spraying will give rise to higher volume loading with subsequent increases in the mechanical properties of sintered compacts.

1. A method of producing nano-composite powder consisting essentially of hydroxyapatite (HA) and zirconium oxide (ZrO₂) comprising the steps of:
reacting orthophosphoric acid with calcium hydroxide to form a HA suspension;
adding zirconium suspension to the HA suspension to form a composite feedstock;
subjecting the composite feedstock to Radio Frequency (RF) Plasma Spraying to form the nano-composite powder.

2. The method according to claim 1, wherein the quantity of zirconium oxide suspension added is in the range of 10 to 40 weight %.

3. A nano-composite powder comprising:
60-90 wt % calcium hydroxyapatite;
10-40 wt % zirconium oxide; and
traces of calcium phosphate.
